(19) United States
(12) Patent Application Publication
(10) Pub. No.: US 2009/0169284 A1
(43) Pub. Date: Jul. 2, 2009

(54) STRUCTURE OF AUTOMATIC PENCIL

(75) Inventor: Yu-Chien Yang, Sijhih City (TW)

Correspondence Address: ROGER H. CHU, 19499 ERIC DRIVE, SARATOGA, CA, 95070, US

(73) Assignee: LINK UPON ADVANCED MATERIAL CORP., Shulin City (TW)

(21) Appl. No.: 12/258,982

(22) Filed: Oct. 27, 2008

(30) Foreign Application Priority Data
Dec. 28, 2007 (TW) 096222412

(51) Int. Cl. B43K 21/22

(52) U.S. Cl. 401/94

(57) ABSTRACT

An automatic pencil includes a pencil tube unit, a pencil tip unit, a press cap and an eraser unit. The pencil tube unit includes an external tube member and a pencil refill tube member contained in the external tube member and having a clamping portion for clamping the pencil refill. The pencil tip unit is connected to the external tube member and includes a retainer connected to the clamping portion in the pencil refill tube member and a pencil refill guide tube situated at a conical tip of the conical body and connected to the retainer to guide the pencil refill. The press cap is installed at the pencil refill tube member, and a protrusion is formed along its axis. The eraser unit includes an eraser and at least one spare eraser, both having a surface and a concave hole for connecting the protrusion of the press cap.

### FIELD OF THE INVENTION

The present invention generally relates to pencils, and more particularly to an improved structure of an automatic pencil that can change its eraser.

### BACKGROUND OF THE INVENTION

For long, pencil has been used as a writing tool for our work or learning in our daily life to record words and draw pictures in places all over the world.

As time advances, an automatic pencil is introduced to save the process of sharpening a traditional pencil and eliminating the issue of having a blunt pencil tip. The automatic pencil enhances the convenience of use greatly, and thus replaces the traditional pencil gradually, and becomes one of the popular writing tools in our daily life.

In general, an eraser is installed at an upper end of the automatic pencil and provided for users to make corrections for an error made in a written document or a drawn figure, but the conventional automatic pencil usually comes with a fixed eraser, and thus the eraser may break, wear out or deteriorate after several times of use, and such eraser cannot be used anymore and causes inconvenience to users.

Manufacturers in the related industry attempted to improve the forgoing problem by providing feasible solutions such as a roller controlled eraser that can shift the position of the eraser, or a rotatable tube that can rotate the eraser upward in the automatic pencil.

However, the foregoing improvements require additional components of the automatic pencil and thus such pencil incurs a higher cost. The improved effect is insignificant due to the structural design, so that the present invention provides an improved structure of an automatic pencil without increasing the cost or installing additional components.

### SUMMARY OF THE INVENTION

Therefore, it is a primary objective of the present invention to provide an improved structure of an automatic pencil, particularly an automatic pencil capable of replacing an eraser in an easy manner.

The improved structure of an automatic pencil comprises a pencil tube unit, a pencil tip unit, a press cap and an eraser unit. The pencil tube unit includes a pencil refill tube member and an external tube member, and the pencil refill tube member is a hollow tubular object having upper and lower open ends for containing a pencil refill and passing the pencil refill, and the upper and lower open ends have a clamping portion for clamping the pencil refill, and the clamping portion includes a resilient member sheathed into the pencil refill tube member. The external tube member is a hollow tubular object having an open end and a closed end, and its internal tube diameter is greater than the external tube diameter of the pencil refill tube member for accommodating the pencil refill tube member, and a guide hole is disposed at the closed end for passing the clamping portion of the pencil refill tube member into the guide hole.

The pencil tip unit is a hollow conical body, and its bottom and conical tip have an opening separately, and the opening at the bottom is connected to the closed end of the external tube member, and the conical body has a retainer and a pencil refill guide tube. The retainer is situated at the bottom in the conical body for retaining the clamping portion in the pencil refill tube member. The pencil refill guide tube is passed through the conical tip of the conical body and connected to the retainer for guiding the pencil refill.

The press cap is a hollow casing in a short cylindrical shape, and one of the surfaces has an upper casing and another surface forms an opening, and the internal diameter of the opening is greater than the external tube diameter of the pencil refill tube member, such that the press cap can be sheathed onto an open end of the pencil refill tube member, and a protrusion is formed at the middle of the upper casing and disposed upward from the axis of the press cap.

The eraser unit includes an eraser and at least one spare eraser, and a concave hole is disposed at the middle of a surface of the eraser and corresponding to the protrusion of the press cap, such that the eraser is sheathed onto the press cap, and a concave hole is disposed at the middle of a surface of the spare eraser and corresponding to the protrusion of the press cap, such that the spare eraser can be sheathed onto the press cap for replacing the eraser.

To make it easier for our examiner to understand the technical characteristics and effects of the present invention, we use preferred embodiments with accompanying drawings for the detailed description of the invention. However, the embodiments and drawings are provided for illustrating the invention, but not intended for limiting the scope of the invention.

### BRIEF DESCRIPTION OF THE DRAWINGS

FIG. 1 is an exploded view of an improved structure of an automatic pencil in accordance with a first preferred embodiment of the present invention;

FIG. 2 is a perspective view of an improved structure of an automatic pencil in accordance with a first preferred embodiment of the present invention;

FIG. 3 is a perspective view of a spare eraser of an improved structure of an automatic pencil in accordance with a first preferred embodiment of the present invention; and

FIG. 4 is a perspective view of an improved structure of an automatic pencil in accordance with a first preferred embodiment of the present invention.

### DETAILED DESCRIPTION

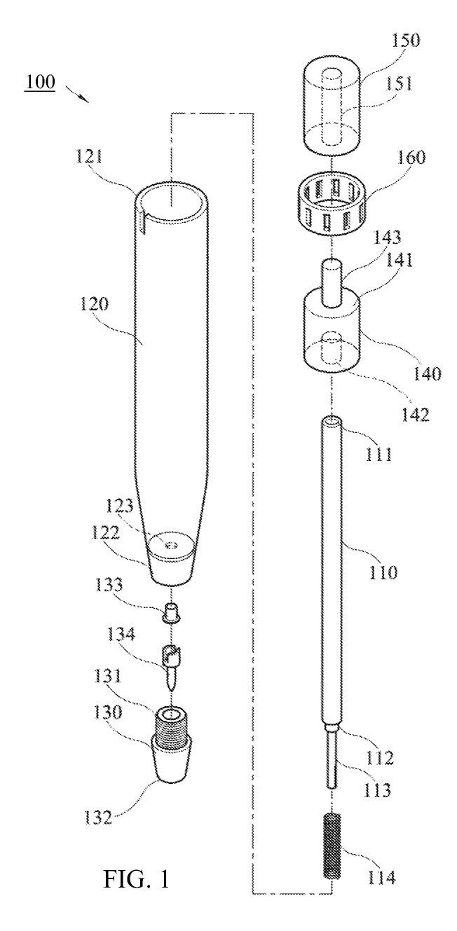

With reference to FIG. 1 for an exploded view of an improved structure of an automatic pencil in accordance with a first preferred embodiment of the present invention, the automatic pencil 100 comprises a pencil refill tube 110, an external tube 120, a pen tip 130, a press cap 140, an eraser 150 and a movable latch ring 160; and the pencil refill tube 110 is a hollow tubular object having an upper open end 111 and a lower open end 112; a clamping portion 113 installed in the lower open end 112, and having a spring 114 sheathed onto the clamping portion 113.

The external tube 120 is a hollow tubular object with the internal tube diameter greater than the external tube diameter of the pencil refill tube 110, and both sides of the external tube 120 are an open end 121 and a closed end 122 respectively, and both define a containing space in the external tube 120 having an opening for accommodating the pencil refill tube 110 in the containing space; and the closed end 122 has a guide hole 123 for passing the clamping portion 113 and the spring 114 of the pencil refill tube 110 through the guide hole 123 to connect the pen tip 130.

The pen tip 130 is a hollow conical body having an opening 131 at the bottom of the pen tip 130 for coupling the closed end 122 of the external tube 120, and a conical tip of the pen tip 130 has an opening 132. The pen tip 130 further contains a retainer 133 and a pencil refill guide 134, and the retainer 133 disposed at the bottom of the pen tip 130 is retained and connected to the clamping portion 113 of the pencil refill tube 110, and the pencil refill guide 134 is connected to the retainer 133 and passed through the conical tip opening 132 to guide the pencil refill to the outside.

The press cap 140 is a hollow casing in a short cylindrical shape, wherein a surface has an upper casing 141 and another surface forms an opening 142, and a cylindrical protrusion 143 is formed at the middle of the upper casing 141 and disposed upward from the axis of the press cap, and the opening 142 of the press cap 140 has an internal diameter greater than the external tube diameter of the pencil refill tube 110, such that the press cap 140 can be sheathed at the upper open end 111 of the pencil refill tube 110.

The eraser 150 has a concave hole 151 disposed at the middle of a surface and along the axis of the eraser 150, and the diameter and depth of the eraser 150 correspond to the cylindrical protrusion 143 of the press cap 140 for combining the eraser 150 with the press cap 140 through the concave hole 151 for fixing the eraser 150 with the press cap 140 by a movable latch ring 160.

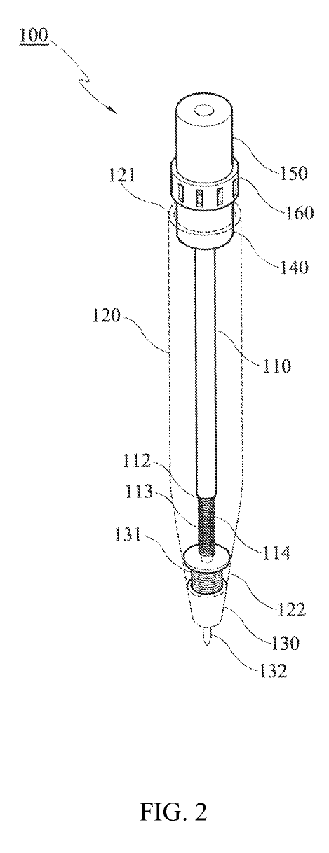

With reference to FIG. 2 for a schematic view of an improved structure of an automatic pencil in accordance with a first preferred embodiment of the present invention, the pencil refill tube 110 is penetrated through the external tube 120, and its lower open end has a clamping portion 113, and a spring 114 sheathed onto the external periphery of the clamping portion 113, and the clamping portion 113 and the spring 114 are passed through the external tube guide hole 123 and entered into the pen tip 130 connected to the external tube 120 and combined with the pencil refill guide 132 in the pen tip 130, such that the pencil refill of the automatic pencil is guided to the outside of the pen tip 130, and a press cap 140 is connected to the upper open end of the pencil refill tube.

The press cap 140 further includes an eraser 150, and a movable latch ring 160 provided for fixing the eraser 150 and the press cap 140 at corresponding positions, and the eraser 150 can be exposed or covered by using the movable latch ring 160 for users to remove/install an eraser 150 from/to the press cap 140 to form a mechanism to facilitate replacing the eraser with another spare eraser.

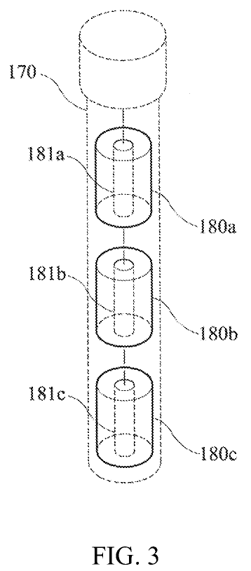

With reference to FIG. 3 for a perspective view of a spare eraser of an improved structure of an automatic pencil in accordance with a first preferred embodiment of the present invention, a plurality of spare erasers 180a, 180b, 180c are installed in a spare eraser barrel 170, and the plurality of erasers have axial holes 181a, 181c or a concave hole 181b disposed axially at the middle of a surface, and its diameter and depth correspond to the cylindrical protrusion 143 of the press cap 140, such that the spare erasers 180a, 180b, 180c can be combined with the press cap 140 for replacing the eraser 150.

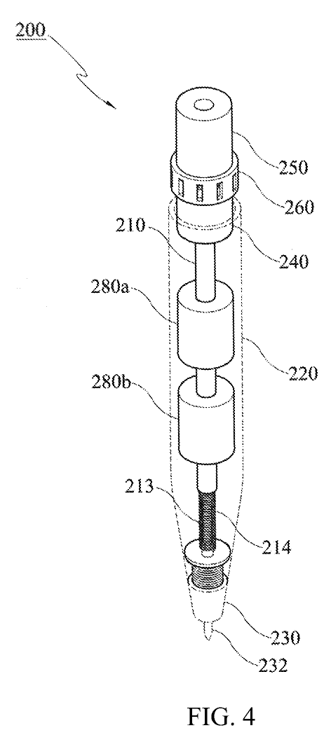

The improved structure of the automatic pencil in accordance with the present invention not only can use the aforementioned assembly to replace a spare eraser, but also can use other methods for the connection. With reference to FIG. 4 for a perspective view of an improved structure of an automatic pencil in accordance with a second preferred embodiment of the present invention, the automatic pencil 200 comprises a pencil refill tube 210, an external tube 220, a pen tip 230, a press cap 240, an eraser 250, a movable latch ring 260 and a plurality of spare erasers 280a, 280b. The pencil refill tube 210 is penetrated through the external tube 220, and its lower open end is installed at the clamping portion 213, and a spring 214 is sheathed at the external periphery of the clamping portion 213, and the clamping portion 213 and the spring 214 are passed through the external tube 220 and entered into the pen tip 230 connected to the external tube 220 and combined with the pencil refill guide 232 in the pen tip 230, such that the pencil refill of the automatic pencil can be guided to the outside of the pen tip 230.

The spare erasers 280a, 280b are short cylindrical objects with a diameter smaller than the internal tube diameter of the external tube 220, and an axial length shorter than the axial length of the external tube 220. The spare erasers 280a, 280b have an axial hole at the middle, and the hole diameter is substantially equal to the external tube diameter of the pencil refill tube 210, such that the spare erasers 280a, 280b can be passed through the pencil refill tube 210 and accommodated in the containing space of the external tube 220.

A press cap 240 is sheathed onto the upper open end of the pencil refill tube 210 and an eraser 250 is sheathed onto the top of the press cap 240 and a movable latch ring 260 is provided for fixing the eraser 250 and the press cap 240 in corresponding positions, and the eraser 250 can be exposed or covered by using the movable latch ring 260 to remove/install the eraser 250 from/to the press cap 240 easily, so as to facilitate replacing the spare eraser 280a, 280b.

In summation of the description above, the present invention improves over the prior art and complies with the patent application requirements, and thus is duly filed for patent application. While the invention has been described by means of specific embodiments, numerous modifications and variations could be made by those skilled in the art without departing from the scope and spirit of the invention set forth in the claims.

What is claimed is:

1. An improved structure of an automatic pencil, comprising:
a pencil tube unit, comprising:
a pencil refill tube member, being a hollow tubular object, having upper and lower open ends, for accommodating a pencil refill and passing the hollow tubular object, and a clamping portion being disposed in the lower open end for clamping the pencil refill, and the clamping portion having a resilient member sheathed into the pencil refill tube member; and an external tube member being a hollow tubular object and having an open end and a closed end, such that the external tube member forms a containing space, and the internal tube of the hollow tubular object having a diameter greater than the external tube diameter of the pencil refill tube member for accommodating the pencil refill tube member;
the closed end having a guide hole for passing the open end with the clamping portion of the pencil refill tube member through the guide hole;
a pencil tip unit, being a hollow conical body, and having an opening disposed on a bottom and a conical tip of the pencil tip unit, and the bottom opening being connected to the closed end of the external tube member, and the conical body further comprising:
a retainer, disposed at the bottom in the conical body, for retaining and connecting the clamping portion in the pencil refill tube member; and a pencil refill guide tube, passed through a conical tip of the conical body, and coupled to the retainer, for guiding the pencil refill;
a press cap, being a hollow casing in a short cylindrical shape, and one of the surfaces having an upper casing, and another surface forming an opening, and the internal diameter of the opening being greater than the external tube diameter of the pencil refill tube member, for sheathing the press cap to the upper open end of the pencil refill tube member;
the upper casing, having a protrusion disposed at the middle of the upper casing and protruded upward from the axis of the press cap;
and an eraser unit, comprising:
an eraser, having a concave hole disposed at the middle of the eraser, and the internal diameter and the depth of the concave hole corresponding to the protrusion of the press cap, such that the eraser unit is sheathed on the press cap;
and at least one spare eraser, having a concave hole disposed at the center of a surface, and the internal diameter and the depth of the concave hole corresponding to the protrusion of the press cap, for sheathing the spare eraser onto the press cap and replacing the eraser.

2. The improved structure of an automatic pencil as recited in claim 1, wherein the resilient member of the pencil refill tube member is a spring.

3. The improved structure of an automatic pencil as recited in claim 1, wherein the protrusion of the press cap is a short cylindrical object with a diameter substantially equal to the diameter of the pencil refill tube member.

4. The improved structure of an automatic pencil as recited in claim 1, further comprising a movable latch ring sheathed at the connecting position of the eraser unit and the press cap, for fixing the eraser and the press cap at corresponding positions.

5. The improved structure of an automatic pencil as recited in claim 3, wherein the concave hole of the eraser is penetrated through the eraser body to form an axial hole, and the internal diameter of the axial hole matches with the short cylindrical object of the press cap, such that the eraser can be sheathed onto the press cap from any one of the two surfaces.

6. The improved structure of an automatic pencil as recited in claim 3, wherein the concave hole of the spare eraser is penetrated through the eraser body to form an axial hole, and the internal diameter of the axial hole matches with the short cylindrical object of the press cap, such that the spare eraser can be sheathed onto the press cap from any one of the two surfaces.

7. The improved structure of an automatic pencil as recited in claim 4, wherein the spare eraser is a cylindrical body with an external diameter smaller than the internal diameter of the external tube member, and an axial length smaller than the axial length of the external tube member, and the axial hole of the spare eraser has an internal diameter larger than the external tube diameter of the pencil refill tube member, such that the spare eraser can be penetrated through the pencil refill tube member and accommodated in the external tube member.
